(19) United States
(12) Patent Application Publication
(10) Pub. No.: US 2022/0306469 A1
(43) Pub. Date: Sep. 29, 2022

(54) HYDROGEN PURIFICATION

(71) Applicant: HALDOR TOPSØE A/S, Kgs. Lyngby (DK)

(72) Inventor: Peter Mølgaard MORTENSEN, Roskilde (DK)

(73) Assignee: HALDOR TOPSØE A/S, Kgs. Lyngby (DK)

(21) Appl. No.: 17/610,774

(22) PCT Filed: May 7, 2020
(86) PCT No.: PCT/EP2020/062731

§ 371 Date: Nov. 12, 2021

(30) Foreign Application Priority Data
May 31, 2019 (DK) PA 2019 00674

(51) Int. Cl. C01B 3/56; C01B 3/34; B01D 53/04

(52) U.S. Cl. CPC C01B 3/56; C01B 3/34; B01D 53/0462; C01B 2203/0216; C01B 2203/0283; C01B 2203/0415; C01B 2203/043; C01B 2203/1241; C01B 2203/146; C01B 2203/148; C01B 2203/141; C01B 2203/0475; B01D 2256/16; B01D 2253/108; B01D 2253/102; B01D 2253/204; B01D 2259/40086; B01D 2259/4009

(57) ABSTRACT

A plant and method for hydrogen purification are provided, which comprise a Swing Adsorption (SA) stage and a recycle of purged gaseous impurities.

### TECHNICAL FIELD

The present invention relates to a plant and method for hydrogen purification, which comprise a Swing Adsorption (SA) stage and a recycle of purged gaseous impurities.

### BACKGROUND

Production of hydrogen in a steam reforming process requires a purification step. In steam reforming, this is done by Pressure Swing Absorption, PSA. PSA will however also retain part of the hydrogen, which is why this technology typically gives a yield of 80-90% hydrogen. The remaining hydrogen is lost in a low pressure off-gas which is best used for heating elsewhere in the plant.

A more efficient hydrogen separation technology than PSA is desirable, which can avoid overdesign of steam reforming plants.

### SUMMARY

A plant for providing an H₂-rich gas stream from a hydrocarbon feed is provided, said plant comprising:
a reformer section arranged to receive said hydrocarbon feed and reform it in at least one reforming step conducted at a forst pressure to provide a synthesis gas stream;
a CO₂ removal stage, arranged to receive the synthesis gas stream from said reformer section and separate CO₂ from the synthesis gas stream, so as to provide a CO₂-rich stream and a CO₂-poor stream;
a swing adsorption (SA) stage, said SA stage comprising an adsorption material and a first purge stream with a pressure equal to or higher than the first pressure ; and being arranged to receive the CO₂-poor stream from the CO₂ removal stage;
wherein said SA stage comprises a first state (A) and a second state (B), wherein;
   in said first state (A), the CO₂-poor stream is arranged to contact the adsorption material so that;
      at least a portion of the gaseous impurities from said CO₂-poor stream, and
      a portion of the hydrogen from said CO₂-poor stream, are adsorbed onto said adsorption material, thus providing an H₂-rich stream;
   in said second state (B), the first purge stream is arranged to contact the adsorption material so that at least a portion of the adsorbed gaseous impurities and at least a portion of said adsorbed hydrogen are released from said adsorption material and into the first purge stream; thereby providing a first recycle stream comprising said first purge stream, hydrogen and said gaseous impurities;
said plant being arranged to recycle said first recycle stream to the reformer section as feed for the reforming step.

The present technology also provides a method for providing an H₂-rich gas stream from a hydrocarbon feed. The method comprises the general steps of:
i. providing a plant as described herein;
ii. feeding the hydrocarbon feed to the reformer section and reforming it in at least one reforming step conducted at a first pressure to provide a synthesis gas stream;
iii. feeding the synthesis gas stream from said reformer section to the CO₂ removal stage, and separating CO₂ from the synthesis gas stream, so as to provide a CO₂-rich stream and a CO₂-poor stream;
iv. feeding the CO₂-poor stream from the CO₂ removal stage to the swing adsorption (SA) stage comprising an adsorption material and a first purge stream with a pressure equal to or higher than the first pressure, wherein said SA stage comprises a first state (A) and a second state (B), wherein;
   in said first state, the CO₂-poor stream contacts the adsorption material so that
      at least a portion of the gaseous impurities from said CO₂-poor stream, and
      a portion of the hydrogen from said CO₂-poor stream
   are adsorbed onto said adsorption material, thus providing an H₂-rich stream ;
   in said second state, the first purge stream contacts the adsorption material so that at least a portion of the adsorbed gaseous impurities and at least a portion of said adsorbed hydrogen are released from said adsorption material and into the first purge stream; thereby providing a first recycle stream comprising said first purge stream, hydrogen and said gaseous impurities; and
v. recycling said first recycle stream to the reformer section as feed for the reforming step.

Further details of the technology are presented in the following detailed description, the figures and the appended claims.

### LEGENDS

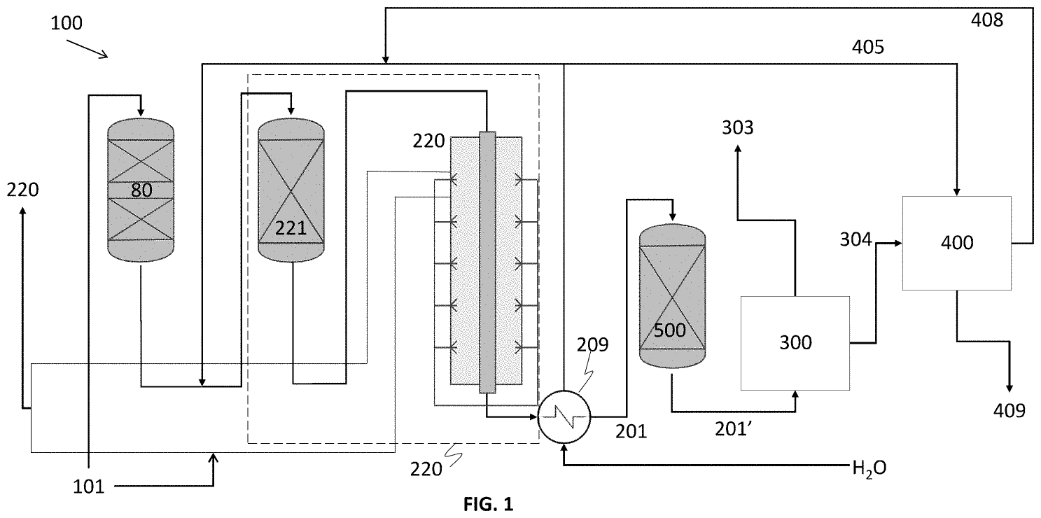

FIG. 1 illustrates a schematic layout of a hydrogen plant according to the present invention.

### DETAILED DISCLOSURE

When a section, unit or stage is “arranged to receive” a particular gas from another section, unit or stage, it is typically arranged to directly receive. However, in certain circumstances, an intermediate section, unit or stage is present, via which the particular gas may be passed.

### Specific Embodiments

In the following the abbreviation % vol shall be used to signify volume percentage for a gas.

A hydrogen plant, i.e. a plant for providing an H₂-rich gas stream from a hydrocarbon feed is provided. The term “H2-rich” should be understood to mean in the order of 95%vol or more.

The hydrocarbon feed is typically selected from natural gas, town gas, naphtha or biogas, and is preferably natural gas. The hydrocarbon feed is characterized by containing a majority (i.e. over 50%) of hydrocarbons e.g. methane, ethane, ethane, propane, butane, butane, and similar. Also, nitrogen, argon, and carbon dioxide, among others, may be present. Notice that the hydrocarbon feed will be mixed with streams containing hydrogen, steam, carbon dioxide, and or oxygen inside the reformer section to facilitate the reforming reaction.

Generally, the plant comprises:
a reformer section;
a CO₂ removal stage; and
a swing adsorption (SA) stage.

The reformer section is arranged to receive the hydrocarbon feed and reform it in at least one reforming step to provide a synthesis gas stream. Reforming of hydrocarbons to synthesis gas is a known procedure, and need not be discussed in detail here.

Typically, and as shown in FIG. 1, the reformer section comprises one or more primary reformer units, and optionally one or more pre-reformer units arranged in the hydrocarbon feed upstream said reformer unit(s). If no pre-reformer units are present, the hydrocarbon feed is received by the primary reformer unit. If pre-reformer units are present, the hydrocarbon feed is received by the pre-reformer unit(s). The one or more primary reformer units may be selected from an autothermal reactor (ATR), a steam methane reforming reactor (SMR), a convective reforming reactor, and/or a catalytic oxidation (CATOX) type reforming reactor.

The CO₂ removal stage is arranged to receive the synthesis gas stream from said reformer section and separate CO₂ from the synthesis gas stream, so as to provide a CO₂-rich stream and a CO₂-poor stream. The CO₂ content in the CO₂-poor steam will typically be below 2%, while the CO₂ rich stream may comprise more than 90% CO₂. By CO₂ removal stage is meant a unit utilizing a process, such as chemical absorption, for removing CO₂ from the process gas. In chemical absorption, the CO₂ containing gas is passed over a solvent which reacts with CO₂ and in this way binds it. The majority of the chemical solvents are amines, classified as primary amines as monoethanolamine (MEA) and digylcolamine (DGA), secondary amines as diethanolamine (DEA) and diiso-propanolamine (DIPA), or tertiary amines as triethanolamine (TEA) and methyldieth-anolamine (MDEA), but also ammonia and liquid alkali carbonates as K₂CO₃ and NaCO₃ can be used.

The swing adsorption (SA) stage comprises an adsorption material and a first purge stream. The adsorption material may be selected from a zeolite, active carbon or metal organic framework, or mixtures thereof. The adsorption material is typically in the form of an adsorption bed inside the SA stage. By swing adsorption, a unit for adsorbing selected compounds is meant. In this type of equipment, a dynamic equilibrium between adsorption and desorption of gas molecules over an adsorption material is established. The adsorption of the gas molecules can be caused by steric, kinetic, or equilibrium effects. The exact mechanism will be determined by the used adsorbent and the equilibrium saturation will be dependent on temperature and pressure. Typically, the adsorbent material is treated in the mixed gas until near saturation of the heaviest compounds and will subsequently need regeneration. The regeneration can be done by changing pressure or temperature, or purging with another stream. In practice, this means that a process with at least two units is used, saturating the adsorbent at high pressure or low temperature initially in one unit, and then switching unit, now desorbing the adsorbed molecules from the same unit by decreasing the pressure or increasing the temperature or purging with another stream.

The SA stage is arranged to receive the CO₂-poor stream from the CO₂ removal stage. The SA stage comprises a first state (A) and a second state (B), and is interchangeable between these states. Changing between states may involve the opening or closing of streams to the SA stage. In one aspect, changing between states involves a change in temperature of the SA stage, i.e. the SA stage is a Temperature Swing Adsorption (TSA) stage. In this aspect, therefore, the temperature of the SA stage in the second state (B) is higher than in said first state (A).

Suitably, the SA stage is arranged to alternate between said first (A) and second (B) states.

To improve efficiency, and to reduce fluctuations in output, the SA stage may have several parallel adsorption reactions being in different stages (A, B) at a given time.

In the first state (A), the CO₂-poor stream is arranged to contact the adsorption material so that;
at least a portion (and preferably all) of the gaseous impurities from said CO₂-poor stream, and
a portion of the hydrogen from said CO₂-poor stream are adsorbed onto said adsorption material. In that only a portion of the hydrogen from the CO₂-poor stream is adsorbed, this leaves non-adsorbed H₂ to continue through the SA stage, thereby providing an H₂-rich stream.

The gaseous impurities are typically one or more of the following gases: CO₂, CO, Ar, H₂O, N₂ and CH₄.

The second state (B) is the purge state, in which the impurities on the adsorption material will be replaced by the purge. In the second state (B) of the SA stage, the first purge stream is arranged to contact the adsorption material so that at least a portion (and preferably all) of the adsorbed gaseous impurities and at least a portion (and preferably all) of said adsorbed hydrogen are released from said adsorption material and into the first purge stream. In this manner, a first recycle stream is provided which comprises the first purge stream, hydrogen and said gaseous impurities in admixture. As illustrated in FIG. 1, the plant is arranged to feed the first recycle stream to the reformer section. The plant may be arranged to feed the first recycle stream upstream the one or more prereformer units, if present.

The SA stage may comprise a second purge stream and a third state (C). In this third state, the second purge stream is arranged to purge contact the adsorption material subsequent to purging with the first purge recycle stream so that at least a portion of the gaseous impurities are released from said adsorption material; thereby providing a second recycle stream which is recycled upstream the reforming step of said reforming section. In this way the adsorption material is flushed with a preferred gas phase before returning to state A and consequently contamination of the H₂-rich stream by the first purge stream used in state B is avoided. The second purge stream may advantageously be hydrogen. In a particular embodiment, the second purge stream has a pressure equal to or higher than the first pressure.

In one preferred aspect, the first purge stream is a stream of superheated steam. Steam is a particularly attractive purge stream as it is required as co-feed to the hydrocarbon feed to the reformer section and therefore the combined stream of the first purge stream with hydrogen and gaseous impurities can be recycled collectively. As illustrated in FIG. 1, additional steam might be added to the recycle to exactly match the required steam addition to the reformer section. Another advantage of using steam is that it can be easily removed from the H₂-rich stream subsequently by condensation. The stream of superheated steam may be arranged to provide at least a part of the temperature increase of the SA stage from the first state (A) to the second state (B). Superheated steam may be obtained from elsewhere in the plant, e.g. other units such as the waste heat boiler and/or steam superheaters in fired heaters/waste heat section.

In an alternative aspect, the first purge stream is a fraction of the hydrocarbon feed, in the form of natural gas. This allows for the combined stream of the first purge stream with hydrogen and gaseous impurities can be recycled collectively to the reformer section.

In a further aspect, the first and/or second purge streams are stream(s) of hydrogen. In this way contamination of the H₂-rich stream by the first purge stream is avoided.

A preferred configuration is to use steam as the first purge stream and no second purge stream. An alternative preferred configuration is to use natural gas as the first purge stream and hydrogen as the second purge stream.

The plant may further comprise a shift section arranged in said synthesis gas stream between said reformer section and said CO₂ removal stage. The shift section is designed to adjust the content of the synthesis gas stream; particularly the H/CO ratio, depending on the desired outcome from the plant and/or the type of hydrocarbon feed.

Notice that suitable heat exchangers/temperature regulations stages and water removal stages are applied as required to facilitate the process. Details of these have not been described, as a person skilled in the art of chemical process design considers these easily adaptable.

The present technology also provides a method for providing an H₂-rich gas stream from a hydrocarbon feed. The method comprises the general steps of:
i. providing a plant as described herein;
ii. feeding the hydrocarbon feed to the reformer section and reforming it in at least one reforming step conducted at a first pressure to provide a synthesis gas stream;
iii. feeding the synthesis gas stream from said reformer section to the CO₂ removal stage, and separating CO₂ from the synthesis gas stream, so as to provide a CO₂-rich stream and a CO₂-poor stream;
iv. feeding the CO₂-poor stream from the CO₂ removal stage to the swing adsorption (SA) stage comprising an adsorption material and a first purge stream with a pressure equal to or higher than the first pressure, wherein said SA stage comprises a first state (A) and a second state (B), wherein;
   in said first state, the CO₂-poor stream contacts the adsorption material so that
      at least a portion of the gaseous impurities from said CO₂-poor stream, and
      a portion of the hydrogen from said CO₂-poor stream
   are adsorbed onto said adsorption material, thus providing an H₂-rich stream ;
   in said second state, the first purge stream contacts the adsorption material so that at least a portion of the adsorbed gaseous impurities and at least a portion of said adsorbed hydrogen are released from said adsorption material and into the first purge stream; thereby providing a first recycle stream comprising said first purge stream, hydrogen and said gaseous impurities; and
v. recycling said first recycle stream to the reformer section as feed for the reforming step.

Suitably, in said method, the SA stage is initially in said first state (A), and then alternates between said first (A) and second (B) states. As above, it is preferred that the temperature of the SA stage in the second state (B) is higher than in said first state (A).

All details of the plant above are relevant for the method described herein, mutatis mutandis.

The present invention is based on the recognition that it is possible to recycle part of the hydrogen produced in the swing adsorption stage and use it as feed in the reforming step with the object of increasing the overall hydrogen yield of the plant. The present invention is furthermore based on the recognition that it is feasible to provide the first purge stream of the swing adsorption stage at a pressure of equal to or higher than the pressure of the reforming reaction, and that hence the recycling of the hydrogen-rich stream from the swing adsorption stage to the reforming step may be carried out without any requirement for a compressor.

In particular, the first purge stream may be a part of the hydrocarbon feed to be fed to the reforming step or a part of the superheated steam to be fed to the reforming step and both said streams are available at pressures equal to or higher than the pressure of the reforming step. Also, the first purge stream may a hydrogen stream, which may e.g. be a high pressure stream from a separate process or a part of the hydrogen-rich first recycle stream from the SA stage, which is available at a pressure equal to or higher than the pressure of the reforming step or at a pressure slightly lower than the pressure of the reforming step, in which case the required compression is minimal.

The current technology allows for a high yield of H₂, higher than the 85% of PSA and likely in the order of +95%. The current technology therefore offers a more efficient route for hydrogen production. On an overall plant layout basis, this technology will enable for construction of more contact reformers as the increased yield means less gas needs to be processed to produce a given amount of H₂. This also means that the technology offers lower natural gas consumption and lower CO₂ emissions compared to modern standards.

A higher yield of H₂ can be achieved compared to the use of a Pressure Swing Absorption PSA stage. This will allow for building more compact steam reformers as over-production will not be an issue.

### EXAMPLE 1

Table 1 summarizes an example of the invention. A given amount of hydrocarbon feed (101) is reformed in the reforming section (200) to produce a synthesis gas stream (201). CO₂ is removed from this stream in the CO₂ removal stage (300) to produce a CO₂-poor stream (304) and CO₂-rich stream (303). The CO₂-poor stream (304) is then separated in an SA stage (400) to produce a H₂-rich stream (409). The SA is purged by steam (405) and 50% of this stream is recycled back to the reformer, while the second half is condensed to the leave an off-gas. Also, steam and some hydrogen is added to the reforming section to facilitate prereforming and reforming in this section. Notice that the total feed to the reformer is the mixture of the hydrocarbon feed (101), steam, and hydrogen after being prereformed.

| | | Total | | Syngas to | Syngas | H2 rich | First | |
|---|---|---|---|---|---|---|---|---|
| | Hydrocarbon | feed to | Reformer | CO2-removal | to SA | stream | recycle | Off- |
| | feed (101) | reformer | product | stage | (304) | (409) | stream (408) | gas |
| T [° C.] | 40 | 650 | 920 | 40 | 40 | 45 | 410 | 30 |
| P [barg] | 29.0 | 26.0 | 24.5 | 23.4 | 23.4 | 22.7 | 29 | 0.7 |
| Flow [Nm³/h] | 12784 | 52318 | 75775 | 66195 | 57143 | 37830 | 39752 | 9657 |
| Composition [mole %] | | | | | | | | |
| Carbon Dioxide | 0.1 | 4.3 | 3.9 | 13.4 | 0.0 | 0.0 | 0.0 | 0.0 |
| Nitrogen | 1.0 | 0.4 | 0.3 | 0.3 | 0.4 | 0.1 | 0.2 | 0.9 |
| Methane | 96.6 | 28.6 | 4.2 | 4.8 | 5.6 | 0.0 | 4.0 | 16.6 |
| Ethane | 1.8 | 0.0 | 0.0 | 0.0 | 0.0 | 0.0 | 0.0 | 0.0 |
| Propane | 0.3 | 0.0 | 0.0 | 0.0 | 0.0 | 0.0 | 0.0 | 0.0 |
| n-Butane | 0.1 | 0.0 | 0.0 | 0.0 | 0.0 | 0.0 | 0.0 | 0.0 |
| Isobutane | 0.1 | 0.0 | 0.0 | 0.0 | 0.0 | 0.0 | 0.0 | 0.0 |
| n-Hexane | 0.1 | 0.0 | 0.0 | 0.0 | 0.0 | 0.0 | 0.0 | 0.0 |
| Hydrogen | 0.0 | 12.8 | 56.2 | 73.2 | 84.8 | 99.9 | 13.4 | 55.2 |
| Carbon Monoxide | 0.0 | 0.2 | 14.7 | 8.0 | 9.2 | 0.0 | 6.6 | 27.3 |
| Water | 0.0 | 53.7 | 20.7 | 0.3 | 0.0 | 0.0 | 75.7 | 0.0 |

### EXAMPLE 2

Table 2 summarizes a comparative example where the first recycle 408 from the SA unit is not returned to the reforming section. Similar to Example 1, a given amount of hydrocarbon feed (101) is reformed in the reforming section (200) to produce a synthesis gas stream (201). CO₂ is removed from this stream in the CO₂ removal stage (300) to produce a CO₂-poor stream (304). This is then separated in an SA stage (400) to produce a H₂-rich stream (409). The SA is in this case a more typical PSA, where the off-gas is produced directly. Also, steam and some hydrogen are added to the reforming section to facilitate prereforming and reforming in this section. Notice that the total feed to the reformer is the mixture of the hydrocarbon feed (101), steam, and hydrogen after being prereformed.

| | | Total | | Syngas to | Syngas | H2 rich | |
|---|---|---|---|---|---|---|---|
| | Hydrocarbon | feed to | Reformer | CO2-removal | to SA | stream | Off- |
| | feed (101) | reformer | product | stage | (304) | (409) | gas |
| T [° C.] | 40.0 | 650.0 | 920.0 | 40.0 | 40.0 | 45.0 | 30.0 |
| P [barg] | 29.0 | 26.0 | 24.5 | 23.4 | 23.4 | 22.7 | 0.7 |
| Flow [Nm³/h] | 12784 | 44442 | 65501 | 54494 | 46560 | 32103 | 14458 |
| Composition [mole %] | | | | | | | |
| Carbon Dioxide | 0.1 | 1.5 | 4.2 | 14.2 | 0.0 | 0.0 | 0.0 |
| Nitrogen | 1.0 | 0.3 | 0.2 | 0.2 | 0.3 | 0.1 | 0.6 |
| Methane | 96.6 | 28.0 | 2.9 | 3.5 | 4.1 | 0.0 | 13.2 |
| Ethane | 1.8 | 0.0 | 0.0 | 0.0 | 0.0 | 0.0 | 0.0 |
| Propane | 0.3 | 0.0 | 0.0 | 0.0 | 0.0 | 0.0 | 0.0 |
| n-Butane | 0.1 | 0.0 | 0.0 | 0.0 | 0.0 | 0.0 | 0.0 |
| Isobutane | 0.1 | 0.0 | 0.0 | 0.0 | 0.0 | 0.0 | 0.0 |
| n-Hexane | 0.1 | 0.0 | 0.0 | 0.0 | 0.0 | 0.0 | 0.0 |
| Hydrogen | 0.0 | 5.4 | 55.1 | 75.5 | 88.3 | 99.9 | 62.6 |
| Carbon Monoxide | 0.0 | 0.0 | 12.9 | 6.3 | 7.3 | 0.0 | 23.6 |
| Water | 0.0 | 64.8 | 24.7 | 0.3 | 0.0 | 0.0 | 0.0 |

By the method of the invention presented in example 1, it is shown that the size of the H₂-rich stream (409) is increased from 32103 Nm³/h in the base case of example 2 to 39752 Nm³/h in example 1. Thus, by the method of the invention, the yield of hydrogen from a given amount of hydrocarbon feed (101) is increased by 24%. By increasing the degree of purge stream (405) utilization from the 50% used in example 1, the yield can increase even further. Using 70% of the purge stream instead would result in 29% increased yield of the H₂-rich stream (409).

Other references in the figure:

Preheating section 90

Flue gas 220

Hydrodesulfurisation (HDS) and sulphur adsorption unit 80

heat exchanger/waste heat boiler 209

shifted synthesis gas stream 201′

shift section 500

Although the invention has been described with reference to a number of aspects, examples and embodiments, these aspects, examples and embodiments may be combined by the person skilled in the art, while remaining within the scope of the present invention.

1. A plant for providing an H₂-rich gas stream from a hydrocarbon feed, said plant comprising:
a reformer section arranged to receive said hydrocarbon feed and reform it in at least one reforming step conducted at a first pressure to provide a synthesis gas stream;
a CO₂ removal stage, arranged to receive the synthesis gas stream from said reformer section and separate CO₂ from the synthesis gas stream, so as to provide a CO₂-rich stream and a CO₂-poor stream;
a swing adsorption (SA) stage, said SA stage comprising an adsorption material and a first purge stream with a pressure equal to or higher than the first pressure; and being arranged to receive the CO₂-poor stream from the CO₂ removal stage;
wherein said SA stage comprises a first state and a second state, wherein;
in said first state, the CO₂-poor stream is arranged to contact the adsorption material so that;
at least a portion of the gaseous impurities from said CO₂-poor stream, and
a portion of the hydrogen from said CO₂-poor stream are adsorbed onto said adsorption material, thus providing an H₂-rich stream;
in said second state, the first purge stream is arranged to contact the adsorption material so that at least a portion of the adsorbed gaseous impurities and at least a portion of said adsorbed hydrogen are released from said adsorption material and into the first purge stream; thereby providing a first recycle stream comprising said first purge stream, hydrogen and said gaseous impurities;
said plant being arranged to recycle said first recycle stream to the reformer section as feed for the reforming step.

2. The plant according to claim 1, wherein the SA staged is arranged to alternate between said first and second states.

3. The plant according to claim 1, wherein the temperature of the SA stage in the second state is higher than in said first state.

4. The plant according to claim 1, wherein the SA stage has several parallel adsorption reactions being in different stages (A, B) at a given time.

5. The plant according to claim 1, wherein the SA stage comprises a second purge stream and comprises a third state, in which the second purge streamer is arranged to purge the adsorption material subsequent to purging with the first purge recycle stream so that at least a portion of the gaseous impurities are released from said adsorption material; thereby providing a second recycle stream which is recycled upstream the reforming step of said reforming section.

6. The plant according to claim 1, wherein the adsorption material is selected from a zeolite, active carbon or metal organic framework, or mixtures thereof.

7. The plant according to claim 1, wherein the first purge stream is a stream of superheated steam.

8. The plant according to claim 7, wherein the stream of superheated steam is arranged to provide at least a part of the temperature increase of the SA stage from the first state to the second state.

9. The plant according to claim 1, wherein the first purge stream is a fraction of the hydrocarbon feed, in the form of natural gas.

10. The plant according to claim 1, wherein the first and/or second purge streams are stream(s) of hydrogen.

11. The plant according to claim 1, wherein said reformer section comprises one or more primary reformer units, and optionally one or more pre-reformer units arranged in the hydrocarbon feed upstream said reformer unit(s), and wherein said plant is arranged to feed said first recycle stream upstream the one or more prereformer units.

12. The plant according to claim 1, wherein said one or more primary reformer units are selected from an autothermal reactor (ATR), a steam methane reforming reactor (SMR), a convective reforming reactor, and/or a catalytic oxidation (CATOX) type reforming reactor.

13. The plant according to claim 1, further comprising a shift section arranged in said synthesis gas stream between said reformer section and said CO₂ removal stage.

14. A method for providing an H₂-rich gas stream from a hydrocarbon feed said method comprising:
i. providing a plant according to claim 1;
ii. feeding the hydrocarbon feed to the reformer section and reforming it in at least one reforming step conducted at a first pressure to provide a synthesis gas stream;
iii. feeding the synthesis gas stream from said reformer section to the CO₂ removal stage-, and separating CO₂ from the synthesis gas stream, so as to provide a CO₂-rich stream and a CO₂-poor stream;
iv. feeding the CO₂-poor stream from the CO₂ removal stage to the swing adsorption (SA) stage comprising an adsorption material and a first purge stream with a pressure equal to or higher than the first pressure, wherein said SA stage comprises a first state and a second state, wherein;
in said first state, the CO₂-poor stream contacts the adsorption material so that
at least a portion of the gaseous impurities from said CO₂-poor stream, and
a portion of the hydrogen from said CO₂-poor stream are adsorbed onto said adsorption material, thus providing an H₂-rich stream;
in said second state, the first purge stream contacts the adsorption material so that at least a portion of the adsorbed gaseous impurities and at least a portion of said adsorbed hydrogen are released from said adsorption material and into the first purge stream; thereby providing a first recycle stream comprising said first purge stream, hydrogen and said gaseous impurities; and
v. recycling said first recycle stream to the reformer section as feed for the reforming step.

15. The method according to claim 14, wherein the SA stage is initially in said first state, and then alternates between said first and second states.

16. The method according to claim 14, wherein the temperature of the SA stage in the second state is higher than in said first state.
